(19) United States
(12) Patent Application Publication
(10) Pub. No.: US 2010/0221388 A1
(43) Pub. Date: Sep. 2, 2010

(54) INSTANTLY SOLUBLE COMPOSITIONS FOR CALCIUM FORTIFICATION OF BEVERAGES

(76) Inventors: Yael Policker, Tenafly, NJ (US); Shai Policker, Tenafly, NJ (US)

Correspondence Address: LUCAS & MERCANTI, LLP, 475 PARK AVENUE SOUTH, 15TH FLOOR, NEW YORK, NY, 10016, US

(21) Appl. No.: 12/723,665

(22) Filed: Mar. 14, 2010

Related U.S. Application Data
(63) Continuation-in-part of application No. 12/502,262, filed on Jul. 14, 2009.
(60) Provisional application No. 61/096,874, filed on Sep. 15, 2008.

(51) Int. Cl. A23L 1/304; A23F 3/30; A23L 1/303; B65B 29/02; A23F 5/42

(52) U.S. Cl. 426/73; 426/648; 426/74; 426/78; 426/594

(57) ABSTRACT

The invention provides soluble calcium supplement compositions that provide a clinically significant amount of calcium and optionally sweeteners and/or vitamins, while overcoming the issue of calcium-mediated coagulation in casein-containing beverages, such as coffee or tea with milk, and the issue of visible calcium oxalate particle formation in oxalate-containing beverages, such as black tea. Also provided are prepackaged articles containing the compositions of the invention in multiple and single beverage amounts and methods of using said compositions.

### CROSS-REFERENCE TO RELATED APPLICATIONS

This application is a continuation-in-part of U.S. patent application Ser. No. 12/502,262 filed Jul. 14, 2009, which claims the benefit of U.S. Provisional Patent Application Ser. No. 61/096,874, filed Sep. 15, 2008, each of which is incorporated herein by reference in it entirety.

### FIELD OF THE INVENTION

The present invention relates to nutraceutical compositions and, more particularly, to soluble calcium compositions comprising calcium salts for use in beverages and the like.

### BACKGROUND OF THE INVENTION

Calcium fortification of food and beverages has become increasingly popular in the last several years due to the growing awareness of the need to enhance calcium intake in most age groups of the U.S. population. Calcium fortification is typically performed by adding calcium salt powder to the food or beverage. Once the salt dissolves (either in the product or after ingestion) elemental calcium ions become available for absorption.

Several prior studies have analyzed the bioavailability of calcium salts and have found relatively small differences in them (Rafferty et al., Journal of Food Science—Vol. 72, Nr. 9, R152-R158, 2007). Accordingly, the selection of calcium salt to be used in fortification has mainly related to price, taste and calcium content. However, as recognized by the present inventors, when adding calcium salts to a beverage or to a product intended for use in preparing a beverage additional limiting issues arise. These problems relate to the solubility property of the calcium salt and to the reaction of calcium ions in the solution with additional components of the product and may arise, for example, in the context of sweetener powders, instant beverages powder mix (instant coffee, etc,) and fortification of preparations of tea leaves.

Use of non-soluble calcium salts typically modifies the appearance of the end-product compared to the non-fortified beverage and, therefore, there is an advantage in using soluble calcium salts. Moreover, soluble calcium salts can have different dissolution rates, depending, for example on particle size.

Such quickly soluble salts, such as calcium lactate-gluconate and acetate, have specific taste characteristic which may be detrimental to the taste profile of the subject beverage/product. This issue has been resolved by mixing different calcium salts and/or adding a specific taste component as set forth in U.S. patent application Ser. No. 12/502,262 filed Jul. 14, 2009 and International Patent Application No. PCT/US09/56946 filed Sep. 15, 2009. Despite the advances set forth in these applications, obstacles relating to appearance and palatability remained for certain types of beverages due to the reaction of the dissolved calcium ions with specific beverage components. Specifically, prior to the present invention, two major obstacles to optimal consumer use of and experience with instant calcium salt mixes existed.

First, oxalate content, found, for example, in varying degrees in some kinds of tea leaves, especially black tea, reacts with calcium ions and produces calcium-oxalate salt which is visible as a cloud that affects the salinity, transparency and color of the product and which forms sediment at the bottom of the beverage container. Second, beverages that contain the milk protein Casein such as milk and milk-based beverages, and artificial creamers coagulate in the presence of calcium. This coagulation is visible as curdles resulting in a beverage that displeasingly resembles “spoiled milk”. These problems are exacerbated when soluble calcium powder is used in hot beverages such as tea and coffee, thereby creating a significant barrier for the use of the calcium powder by consumers.

In some cases, when the mix of calcium and oxalate or casein occurs during, or is required in, the process of manufacturing a pre-mixed beverages then the problem may be mitigated by changing the process of mixing so that the reaction is avoided. These solutions however can not be easily implemented for instant beverages in which the end-user creates the mix shortly prior to using it, as when adding soluble calcium salts powder or tablet to a milk-containing beverage and/or tea. In this case the process is defined by the preference of the end-user and any attempt to modify it presents a commercial barrier for consumers

The present invention provides soluble calcium supplement compositions that provide a clinically significant amount of calcium and optionally include sweeteners and/or vitamins such as vitamin D, while overcoming the aforementioned obstacles to use in milk- and oxalate-containing beverages.

### SUMMARY OF THE INVENTION

One embodiment of the invention provides a dry soluble calcium supplement composition that includes a mixture of: one or more soluble calcium salts, collectively containing, for example, at least 50 mg of elemental calcium, such as at least 100 mg of elemental calcium; ascorbic acid in an amount of at least 20 mg per 100 mg of elemental calcium present, but more preferably at least 30 mg ascorbic acid per 100 mg of elemental calcium present; and optionally, one or more quickly soluble magnesium salts such as but not limited to magnesium citrate, magnesium gluconate, magnesium lactate or a mixture thereof. A related composition includes a mixture of one or more soluble calcium salts, collectively containing at least 100 mg of elemental calcium; ascorbic acid in an amount of at least 30 mg ascorbic acid per 100 mg of elemental calcium present; and optionally one or more soluble magnesium salts such as magnesium citrate. It may be further provided for these compositions that in no case will the amount of ascorbic acid be less than 20 mg. The aforementioned mixtures may further include potassium phosphate and/or sodium bicarbonate, each, for example, when present, being in an amount of at least 5 mg or at least 10 mg. Advantageously, these compositions are capable of providing clinically significant amounts of calcium while remaining visibly clear in high oxalate beverages such as black tea.

Another embodiment of the invention provides a dry soluble calcium supplement composition that includes one or more quickly soluble calcium salts, such as one calcium salt or a mixture of calcium salts selected from the group consisting of calcium acetate, calcium lactate, calcium gluconate, calcium lactate-gluconate, calcium chloride, calcium diacetate, calcium glycerophosphate, di and mono calcium phosphate; ascorbic acid; and optionally one or more quickly soluble magnesium salts such as but not limited to magnesium citrate, magnesium gluconate, magnesium lactate or a mixture thereof; and potassium phosphate and/or sodium bicarbonate. The one or more Calcium salts of the composition may collectively contribute at least 50 mg, or at least 100 mg, of elemental calcium while the amount of ascorbic acid in the composition is at least 20 mg and preferably at least 30 mg for each 100 mg of elemental calcium. It may be further provided that in no case will the amount of ascorbic acid be less than 20 mg. In one variation, the calcium salts of the composition include a mixture of calcium acetate, calcium lactate and calcium gluconate or consist predominantly of these three calcium salts. Each of the potassium phosphate and sodium bicarbonate when present may be in an amount of at least 5 mg or at least 10 mg.

Still another embodiment of the invention provides a dry soluble calcium supplement composition that includes a mixture of: one or more soluble calcium salts, collectively containing at least 50 mg, or at least 100 mg, of elemental calcium; and one or more alkali salts, for example, one or more alkali salts selected from the group consisting of potassium phosphate and sodium bicarbonate. This embodiment is particularly useful for use with coffee and formulations of coffee where inhibition of coagulation is desired but where, in contrast to tea, inhibition of oxalate particle formation is not a concern. Thus, one variation of the embodiment provides a composition which is a mixture, such as an admixture of the dry soluble calcium supplement composition of the embodiment and dry instant coffee. The one or more soluble calcium salts collectively may provide at least 50 mg, or at least 100 mg, of elemental calcium per serving, such as per teaspoon or approximately 5 ml of the dry instant coffee composition. The amount of potassium phosphate when present may be at least 5 mg or at least 10 mg, for example, at least 5 mg or at least 10 mg per serving, such as per teaspoon or approximately 5 ml of the dry instant coffee composition. Similarly, the amount of sodium bicarbonate when present may be at least 5 mg or at least 10 mg, for example, at least 5 mg or at least 10 mg per serving, such as per teaspoon or approximately 5 ml of the dry instant coffee composition.

Any of the preceding embodiments and variations thereof may further include vitamin D, such as vitamin D2 (ergocalciferol) and/or vitamin D3 (cholecalciferol) in the mixture.

Any of the preceding embodiments and variations thereof may further include at least one sweetener in the mixture, which may for example, be selected from the group consisting of sugar, sucrose, sucralose, aspartame, saccharin, stevia; acessulfam-k; and neotame.

Any of the preceding embodiments or variations thereof may, for example, be in friable form or in the form of a powder or granules or any combination thereof.

The invention also provides single-use/single-serving packages containing any of the preceding composition embodiments or variations thereof, such as packets or sachets, as well as bulk quantities containing many single-use quantity equivalents. The amount of elemental calcium provided by the one or more calcium salts for a single serving package may, for example, be at least 50 mg or at least 100 mg. Thus, the above mentioned embodiment compositions and variations thereof may be single serving compositions or bulk compositions.

The invention also provides infusible bags such as infusible tea bags that include within (inside) the bags any of the aforementioned composition embodiments or variations thereof. A related embodiment is an infusible tea bag including within it a preparation of tea leaves and any one of the aforementioned composition embodiments or variations thereof. The amount of elemental calcium provided by the one or more calcium salts in such an infusible bag may, for example, be at least 50 mg or at least 100 mg.

The invention also provides a dry (reconstitutable with water) instant coffee composition that includes instant, i.e., dry reconstitutable, coffee; and any one of the aforementioned composition embodiments or variations thereof. The amount of elemental calcium provided by the one or more calcium salts may, for example, be at least 50 mg or at least 100 mg, per serving, such as per teaspoon or approximately 5 ml of such an instant coffee composition.

The invention also provides methods for supplementing a beverage such as a hot beverage, such as tea or coffee, with a clinically significant amount of elemental calcium, such as at least 100 mg, that includes the step of adding any one of the aforementioned composition embodiments or variations thereof, for example, in an amount containing at least 100 mg elemental calcium, to the beverage or to a liquid component of the beverage before the beverage is formed (such as addition to a quantity water before the addition of a tea bag or instant coffee to form the beverage).

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 shows the effect of varying concentrations of ascorbic acid and magnesium citrate on the formation of visible calcium oxalate in black tea preparations to which calcium lactate gluconate has been added.

FIG. 2 shows the effect of varying concentrations of ascorbic acid and magnesium citrate on the formation of visible calcium oxalate in black tea preparations to which calcium acetate has been added.

FIG. 3 shows the effect of varying concentrations of ascorbic acid and magnesium citrate on the formation of visible calcium oxalate in black tea preparations to which calcium gluconate has been added.

FIG. 4 shows the effect of varying concentrations of ascorbic acid and magnesium citrate on the formation of visible calcium oxalate in black tea preparations to which calcium lactate has been added.

FIG. 5 shows the effect of varying concentrations of ascorbic acid and magnesium citrate on the formation of visible calcium oxalate in black tea preparations to which calcium lactate chloride has been added.

### DETAILED DESCRIPTION OF THE INVENTION

The present invention provides soluble calcium supplement compositions that provide a clinically significant amount of calcium and optionally include sweeteners and/or vitamins, while overcoming the obstacle of coagulation for use in milk-containing beverage and the obstacle of calcium oxalate crystal/particle formation in oxalate-containing beverages, such as black tea.

Inhibition of Calcium Oxalate Formation

We hypothesized that the addition of food grade magnesium salts and ascorbic acids to the calcium salt mix may significantly delay calcium oxalate formation in the beverage after the mix is added resulting in a significant improvement in the visible properties of the end product without a need for any special use instructions.

The experimental following data demonstrate the effect of ascorbic acid and magnesium salts on the inhibition of calcium-oxalate formation in tea preparations containing 100 mg of elemental calcium in a cup with 240 ml of boiling water with a single black tea bag.

The data describes the effect of different levels of Mg and ascorbic acid (vitamin C) on appearance of visible calcium oxalate precipitation. The experiments were performed with various soluble calcium salts by adding different levels of ascorbic acid and Magnesium citrate and testing the impact on formation of calcium-oxalate crystals in tea preparations.

In all experiments the amount of calcium salts was chosen so that 100 mg of elemental calcium will be present in the solution. The calcium salt mixture was added and stirred into a cup holding 240 ml of hot black tea made with boiling tap water.

A visual test of transparency was made at 5, 10, 15 and 20 minutes after adding the mixture to the tea for determining any impact on solution clarity by formation of calcium-oxalate crystals. If visible crystals were formed within 10 minutes the result was determined “unacceptable”, if visible crystals were formed between 10-20 minutes then the results was marked “borderline”. If no crystals were visible within 20 minutes the result was marked “acceptable”.

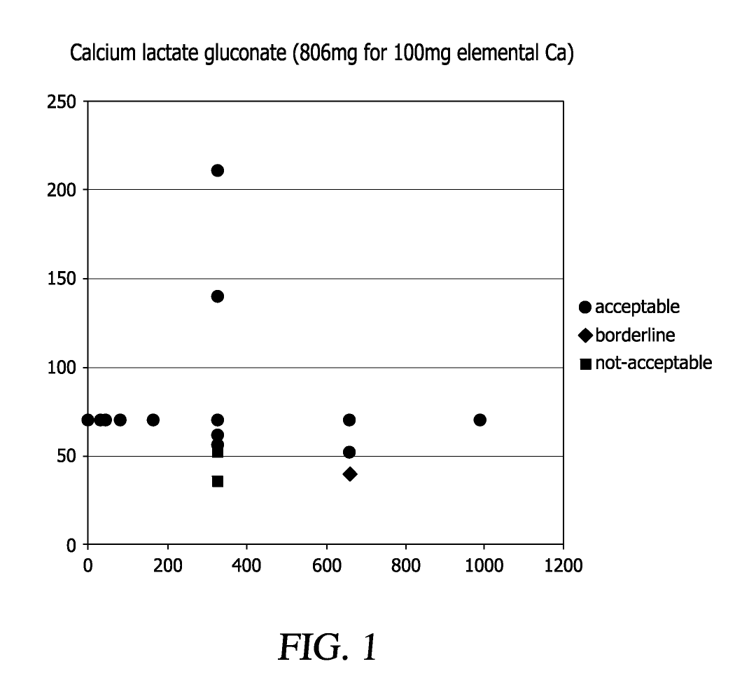

FIGS. 1-5 show the experimental results for various calcium salts. In each of the figures the X-axis marks the amount of Magnesium Citrate (mg) and the Y-axis marks the amount of ascorbic acid (mg). Each indicia of a circle, diamond or square signifies the experimental outcome of a separate experiment; circles indicate an acceptable outcome, diamonds indicate a borderline acceptable (less than optimal) outcome, and squares indicate an unacceptable outcome.

FIG. 1 shows the effect of varying concentrations of ascorbic acid and magnesium citrate on the formation of visible calcium oxalate in black tea preparations to which calcium lactate gluconate (806 mg) has been added.

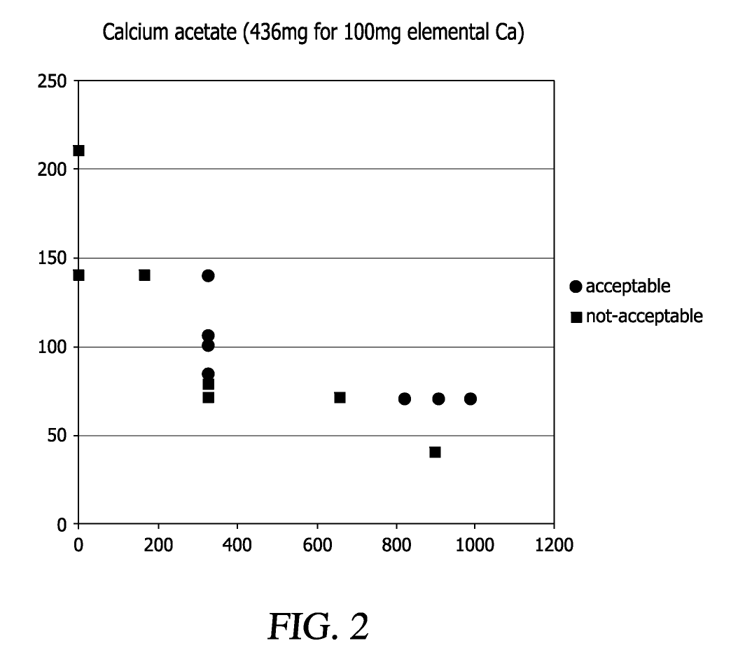

FIG. 2 shows the effect of varying concentrations of ascorbic acid and magnesium citrate on the formation of visible calcium oxalate in black tea preparations to which calcium acetate (436 mg) has been added.

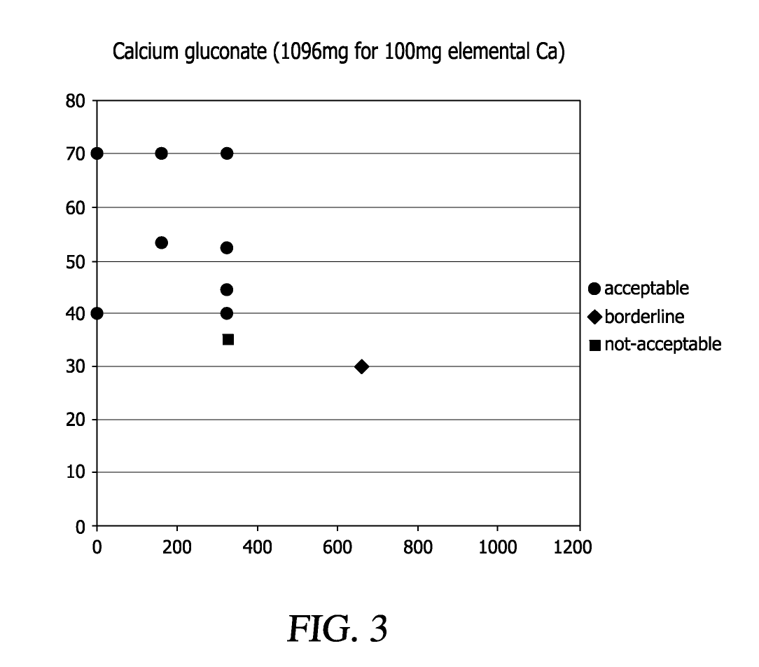

FIG. 3 shows the effect of varying concentrations of ascorbic acid and magnesium citrate on the formation of visible calcium oxalate in black tea preparations to which calcium gluconate (1096 mg) has been added.

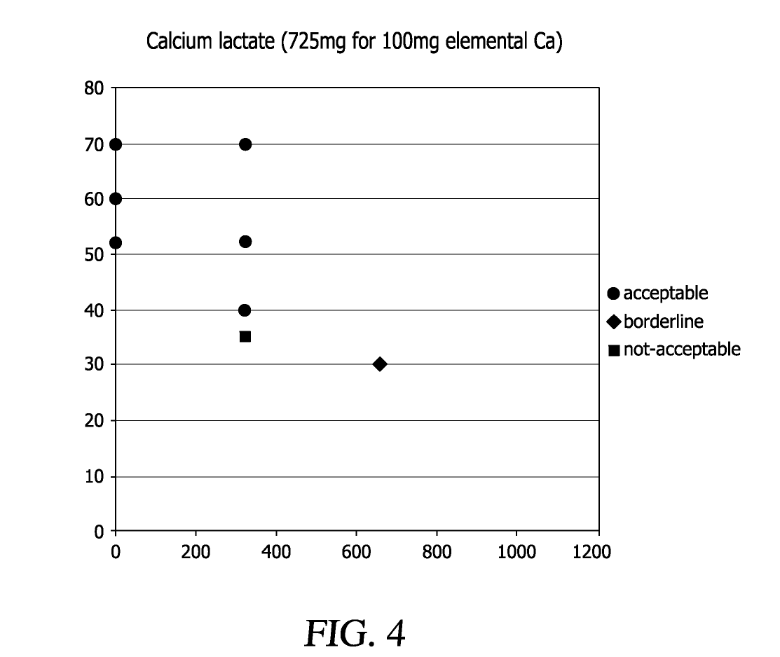

FIG. 4 shows the effect of varying concentrations of ascorbic acid and magnesium citrate on the formation of visible calcium oxalate in black tea preparations to which calcium lactate (725 mg) has been added.

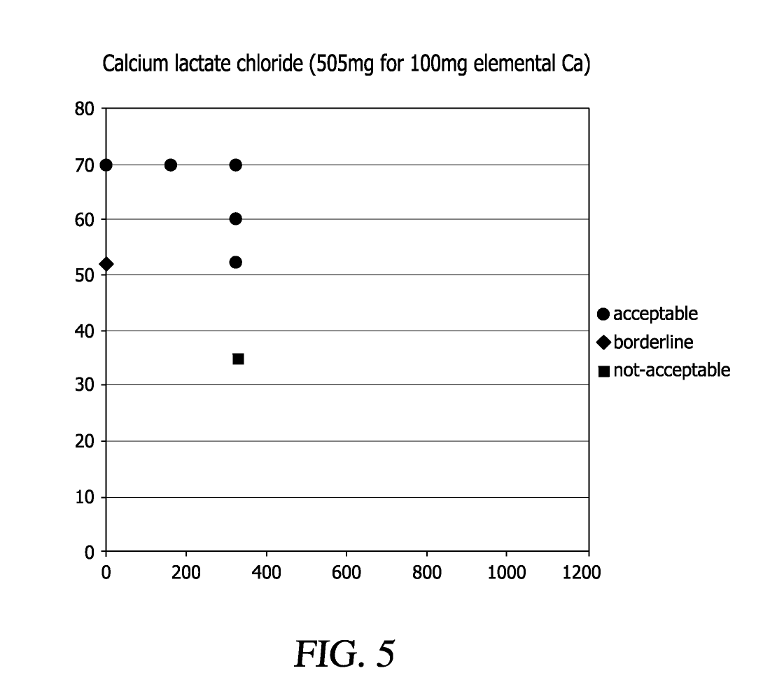

FIG. 5 shows the effect of varying concentrations of ascorbic acid and magnesium citrate on the formation of visible calcium oxalate in black tea preparations to which calcium lactate chloride (505 mg) has been added.

The results shown in FIGS. 1-5 demonstrate that the amounts of ascorbic acid and Magnesium Citrate that are required to delay or prevent calcium oxalate formation depends on the type of calcium salt used but in general a minimal amount of 30 mg of ascorbic acid is required. Use of an additional salt that will have ions electrically similar to calcium is also helpful in delaying the reaction and allow for acceptable results with reduced levels of ascorbic acids. An example for such a salt is Magnesium Citrate which has good solubility, neutral taste and releases doubly charged positive Magnesium ions which compete with the calcium ions. Generally, one or more food grade, quickly soluble Magnesium salts or a mixture thereof may be used, including but not limited to Magnesium citrate, Magnesium gluconate and Magnesium lactate or mixtures therewith. With calcium acetate, the use of such additional “competing salt” is required even with higher level of ascorbic acids. With some other calcium salts, ascorbic acid alone can produce adequate results but it may have some taste impact and increase the cost of the product (due to the relatively high cost of ascorbic acid). In these cases the use of salts like Magnesium Citrate can produce similar results using a significantly reduced quantity of ascorbic acid (see figures).

The combined levels of ascorbic acid and the competing salts depends on the calcium salt used. The differences are mainly associated with the pH of the calcium solution. Calcium salts solutions with similar pH require similar amounts of ascorbic acid/competing salt in order to delay/prevent calcium-oxalate crystal formation. The amount of additive ascorbic acid and competing salt depends on the pH of the solution. The higher the pH the more additives are required for similar result.

Therefore, by adjusting the pH of the solution using other means such as, for example, adding food grade acids to the calcium salt mixture to reduce pH of the solution, the amount of ascorbic acid and competing salt required can be reduced or minimized. The acid used should be selected such that it will have minimal impact on taste, be instantly soluble and suitable for human consumption. A preferred acid is citric acid but those skilled in the art will readily appreciate that others may also be used. The more of such acid added the lower the pH of the resulting calcium solution and the lower is the required additions of competing salts and ascorbic acids for achieving a satisfactory result in preventing calcium-oxalate crystal formation.

Coagulation Inhibition

Coagulation of Casein, the milk protein, is a well known phenomenon in the dairy industry. It is accelerated by the combination of lowered pH excess calcium ions, and by increased temperature.

The use of instant soluble calcium in preparing a beverage creates some or all of these factors. Specifically in preparing a hot beverage (like tea of coffee) with added milk or non-dairy creamer all three factors are present resulting in rapid coagulation kinetics. This coagulation is apparent as curdles in the beverage and make the beverage appearance not attractive and unusable by most consumers.

Reduced temperature and/or use of low fat milk will reduce this effect but such limitations are not desirable for a product that is sought for a widespread adoption by consumers. Therefore, a mixture that will eliminate or significantly delay coagulation under these conditions will have an advantage.

A known way for delaying/inhibiting coagulation is by adding of potassium phosphate which delays coagulation. Potassium phosphate is commonly used in non-dairy coffee creamers that typically contain a large amount of casein and are used in hot beverages. Other alkali soluble powders can also be used as long as their effect on taste and beverage appearance is minimal. However, when a large amount of calcium will be present in the prepared solution, then even the relatively neutral taste potassium phosphate may have a salty affect on taste.

Here, we hypothesized and determined that, in such a case, a mixture of two or more alkali soluble salts could be used to avoid the need for a large amount of a single alkali salt. Such a combination can reduce undesired problems such as unpleasant taste or reduce gas formation (for example, as happens with CO₂ formation when using sodium bicarbonate). We investigated a combination of two alkali salts sodium bicarbonate (SB) and potassium phosphate (PP) at different levels and observed the effect of the mixture with calcium salts (delivering 150 mg of elemental calcium) on coagulation in three preparations containing casein at room temperature: whole milk (about 3% fat), half & half (mix of milk and cream) and casein-containing, non-dairy creamer in water.

The results demonstrate that 10 mg of SB or PP were sufficient to prevent coagulation in whole milk. The lowest level of PP that prevented coagulation in half & half was 500 mg. The lowest level required for preventing coagulation in a creamer preparation was 3000 mg; however, levels as low as 825 mg were sufficient to limit the coagulation to have a minimal and acceptable change in the appearance of the preparation. The amount of SB or PP-containing compositions of the invention may be at least 5 mg or at least 10 mg of SB or PP in the composition, such as at least 10 mg of SB or PP in the composition. For example, the amount of SB or PP may be at least 5 mg or at least 10 mg per serving, such as per teaspoon or approximately 5 ml for instant coffee embodiments or the same amounts within tea bag embodiments. The amount of SB or PP alone, or combined, may for example be in the range of 5 mg-1,000 mg or in the range of 10 mg-1,000 mg, for example, per serving size.

Various aspects and embodiments of the invention are further illustrated by the following examples.

### Example 1

Example 1 illustrates soluble calcium compositions that prevent/inhibit the formation of visible calcium oxalate particles in tea, such as black tea, as shown in Table 1 below.

TABLE 1

| | | Percent |
|---|---|---|
| | Percent Composition | Composition |
| Component | Range | Example |
| Calcium lactate | 50-80% | 64% |
| Magnesium citrate | 29-40% | 31% |
| Ascorbic acid (vitamin C) | min 4% | 5% |
| Total | 100% | 100% |

A typical amount of the composition to be used for a 240 ml (approximately 8 oz.) beverage is in the range of 0.5 to 4.0 grams. One embodiment of the invention provides individual packages, such as packets or sachets, each containing in the range 0.5 to 4.0 grams collectively of the enumerated composition components. The percent compositions given in the above example are relative to the total amount of the above recited components. Thus, the invention provides compositions according to the example that may or may not include only the above-recited components at their enumerated percent compositions. For example, embodiments including the above-recited components at their enumerated percent compositions (with respect to their collective total) plus a sweetener and/or vitamin D (such as vitamin D3) are also provided.

### Example 2

Example 2 illustrates further soluble calcium compositions that prevent/inhibit the formation of visible calcium oxalate particles in tea, such as black tea, as shown in Table 2 below.

TABLE 2

| | | Percent |
|---|---|---|
| | Percent Composition | Composition |
| Component | Range | Example |
| Calcium gluconate | 70-95% | 84% |
| Magnesium citrate | 0-25% | 12% |
| Ascorbic acid (vitamin C) | min 3% | 4% |
| Total | 100% | 100% |

A typical amount of the composition to be used for a 240 ml (approximately 8 oz.) beverage is in the range of 0.5 to 4.0 grams. One embodiment of the invention provides individual packages, such as packets or sachets, each containing in the range 0.5 to 4.0 grams collectively of the enumerated composition components. The percent compositions given in the above example are relative to the total amount of the above recited components. Thus, the invention provides compositions according to the example that may or may not include only the above-recited components at their enumerated percent compositions. For example, embodiments including the above-recited components at their enumerated percent compositions (with respect to their collective total) plus a sweetener and/or vitamin D (such as vitamin D3) are also provided.

### Example 3

Example 3 illustrates soluble calcium compositions that prevent/inhibit the formation of visible calcium oxalate particles in tea, such as black tea, as shown in Table 3 below.

TABLE 3

| | | Percent |
|---|---|---|
| | Percent Composition | Composition |
| Component | Range | Example |
| Calcium acetate | 50-80% | 51% |
| Magnesium citrate | 29-40% | 39% |
| Ascorbic acid (vitamin C) | min 4% | 10% |
| Total | 100% | 100% |

A typical amount of the composition to be used for a 240 ml (approximately 8 oz.) beverage is in the range of 0.5 to 4.0 grams. One embodiment of the invention provides individual packages, such as packets or sachets, each containing in the range 0.5 to 4.0 grams collectively of the enumerated composition components. The percent compositions given in the above example are relative to the total amount of the above recited components. Thus, the invention provides compositions according to the example that may or may not include only the above-recited components at their enumerated percent compositions. For example, embodiments including the above-recited components at their enumerated percent compositions (with respect to their collective total) plus a sweetener and/or vitamin D (such as vitamin D3) are also provided.

### Example 4

Example 4 illustrates soluble calcium compositions effective in preventing milk/casein coagulation for grades of milk ranging from fat free milk to whole fat milk as shown in Table 4 below.

TABLE 4

| | | Percent |
|---|---|---|
| | Percent Composition | Composition |
| Component | Range | Example |
| Calcium acetate | Max 55% | 44% |
| Calcium lactate-gluconate | Max 97% | 51% |
| Potassium phosphate | min 3% | 5% |
| Total | 100% | 100% |

A typical amount of the composition to be used for a 240 ml (approximately 8 oz.) beverage is in the range of 0.5 to 4.0 grams, but other amounts may be used as desired. One embodiment of the invention provides individual packages, such as packets or sachets, each containing in the range 0.5 to 4.0 grams collectively of the enumerated composition components. The percent compositions given in the above example are relative to the total amount of the above recited components. Thus, the invention provides compositions according to the example that may or may not include only the above-recited components at their enumerated percent compositions. For example, embodiments including the above-recited components at their enumerated percent compositions (with respect to their collective total) plus a sweetener and/or vitamin D (such as vitamin D3) are also provided.

### Example 5

Example 5 illustrates further soluble calcium compositions effective in preventing milk/casein coagulation for grades of milk ranging from fat free milk to whole fat milk as shown in Table 5 below.

TABLE 5

| | | Percent |
|---|---|---|
| | Percent Composition | Composition |
| Component | Range | Example |
| Calcium gluconate | max 98% | 96% |
| Potassium phosphate | min 2% | 4% |
| Total | 100% | 100% |

A typical amount of the composition to be used for a 240 ml (approximately 8 oz.) beverage is in the range of 0.5 to 4.0 grams, but other amounts may be used as desired. One embodiment of the invention provides individual packages, such as packets or sachets, each containing in the range 0.5 to 4.0 grams collectively of the enumerated composition components. The percent compositions given in the above example are relative to the total amount of the above recited components. Thus, the invention provides compositions according to the example that may or may not include only the above-recited components at their enumerated percent compositions. For example, embodiments including the above-recited components at their enumerated percent compositions (with respect to their collective total) plus a sweetener and/or vitamin D (such as vitamin D3) are also provided.

### Example 6

Example 6 illustrates soluble calcium compositions effective in preventing milk/casein coagulation for cream-containing and half-and-half-containing beverages, as well as for beverages containing casein-containing non-dairy creamer, as shown in Table 6 below.

TABLE 6

| | | Percent |
|---|---|---|
| | Percent Composition | Composition |
| Component | Range | Example |
| Calcium acetate | Max 45% | 20% |
| Calcium lactate-gluconate | Max 55% | 25% |
| Potassium phosphate | min 45% | 55% |
| Total | 100% | 100% |

A typical amount of the composition to be used for a 240 ml (approximately 8 oz.) beverage is in the range of 0.5 to 8.0 grams, but other amounts may be used as desired. One embodiment of the invention provides individual packages, such as packets or sachets, each containing in the range 0.5 to 4.0 grams collectively of the enumerated composition components. The percent compositions given in the above example are relative to the total amount of the above recited components. Thus, the invention provides compositions according to the example that may or may not include only the above-recited components at their enumerated percent compositions. For example, embodiments including the above-recited components at their enumerated percent compositions (with respect to their collective total) plus a sweetener and/or vitamin D (such as vitamin D3) are also provided.

### Example 7

Example 7 illustrates soluble calcium compositions that prevent both oxalate formation and coagulation as shown in Table 7 below.

TABLE 7

| | | Percent |
|---|---|---|
| | Percent Composition | Composition |
| Component | Range | Example |
| Calcium acetate | Max 45% | 27% |
| Calcium lactate-gluconate | Max 55% | 31% |
| Potassium phosphate | min 2% | 3% |
| Magnesium citrate | min 20% | 33% |
| Ascorbic acid (vitamin C) | min 4% | 6% |
| Total | 100% | 100% |

A typical amount of the composition to be used for a 240 ml (approximately 8 oz.) beverage is in the range of 0.5 to 8.0 grams, but other amounts may be used as desired. One embodiment of the invention provides individual packages, such as packets or sachets, each containing in the range 0.5 to 4.0 grams collectively of the enumerated composition components. The percent compositions given in the above example are relative to the total amount of the above recited components. Thus, the invention provides compositions according to the example that may or may not include only the above-recited components at their enumerated percent compositions. For example, embodiments including the above-recited components at their enumerated percent compositions (with respect to their collective total) plus a sweetener and/or vitamin D (such as vitamin D3) are also provided.

All components used in the preceding experiments were Food Chemical Codex (FCC) compatible. As to the specific salts used in the experiments Calcium lactate-gluconate was Puracal XPro (Purac), Calcium lactate was Calcium 1-lactate 5-hydrate, Calcium lactate-chloride was Puracal ACT 200 (Purac); a blend of Ca lactate and Ca chloride), Calcium acetate was Calcium diacetate, and Potassium phosphate was Potassium phosphate dibasic anhydrous. Although Potassium phosphate dibasic is preferred, any one or a combination of Mono-, Di- and Tri-potassium phosphate may also be used.

The invention may be implemented with one of or a mixture of any food-grade, quickly soluble calcium salts suitable for human consumption, such as but not limited to Calcium acetate, Calcium lactate, Calcium gluconate, Calcium lactate-gluconate, Calcium chloride, Calcium diacetate, calcium glycerophosphate, and di and mono calcium phosphate. In one variation, a mixture of calcium salts including calcium acetate, calcium lactate and calcium gluconate is used.

Any of the embodiments of the invention or variations thereof may further include vitamin D, such as vitamin D3, in an amount up to 800 IU, for example, 40 U to 800 IU, such as about 100 IU, about 200 IU, about 300 IU, about 400 IU, about 500 IU, about 600 IU, about 700 IU, or about 800 IU per 0.5-8.0 grams of the collective composition components for each of the embodiments of Tables 1-7. Where the soluble calcium supplements of the invention are individually packaged, these amounts of vitamin D may be present in an individual serving size. Similarly, these amounts of vitamin D may be present in an infusible bag embodiment of the invention, or in a teaspoon (approximately 5 ml) of a sweetener or instant coffee embodiment of the invention. Vitamin D is not substantially water-soluble but the very small amounts that may be admixed as part of the soluble calcium compositions of the invention are readily dispersible in liquid beverages and do not impact taste or clarity of the beverages. In this regard, it should also be clearly understood that not every component of a soluble calcium composition of the invention need be water soluble to an appreciable extent, as exemplified by vitamin D.

Any of the embodiments of the invention or variations thereof may include one or more sweeteners such as caloric or non-caloric sweeteners or a mixture thereof. Caloric sweeteners include, for example, sucrose. Intense sweeteners that may be used include, but are not limited to, sucralose, aspartame, saccharin, stevia, acessulfam-K, and neotame. Any mixture of sweeteners may also be used. An intense sweetener (or combination of intense sweeteners) may, for example, be added such that with respect to the composition components for each of the embodiments of Tables 1-7 plus the sweetener(s) combined therewith, the sweetener represents 1-3% and the collective components set forth in the embodiments of Tables 1-7 represent 97-99% of the combination (without respect to other components that may optionally be present such as fillers, vitamin D, etc). An amount of the soluble calcium supplement composition embodiments of the invention may be provided such that a single serving size of the sweetener composition containing it provides at least 50 mg or at least 100 mg of elemental calcium from the collective calcium salts. For example, sugar fortified with one of the soluble calcium supplement composition embodiments of the invention may provide at least 50 mg or at least 100 mg of elemental calcium from the collective calcium salts per serving, such as per teaspoon (approximately 5 ml) of the fortified sugar.

In addition, any of the embodiments of the invention or variations thereof may include anti-caking agents such as those known in the art including, but not limited to, calcium silicate and/or tri-calcium phosphate. Such agents inhibit the caking of the compositions during storage and help to maintain the desired flow characteristics of powders, granules and the like.

Throughout this disclosure where the limitations “at least 50 mg” is recited, an amount of 50 mg may, for example, be used and where “at least 100 mg” is recited, an amount of 100 mg may, for example, be used. Moreover, throughout this disclosure, where the limitation “at least 50 mg” is recited, an amount in the range of 50 mg-200 mg may, for example, be used and where the limitation “at least 100 mg” is recited, an amount in the range of 100 mg-200 mg may, for example, be used.

As used throughout this disclosure, the term “tea” refers to preparations of leaves of Camellia sinensis, such as white, yellow, green, oolong, and black teas as known in the art, and to the tea beverages made therewith.

Quickly soluble or fast-soluble calcium salts that may be used in connection with the present invention are defined as those calcium salts for which an amount of the salt containing 100 mg elemental calcium fully dissolves in 100 ml of water upon gentle mixing for no more than 30 seconds at a water temperature of 90-100 degrees Celsius. Moreover, in general, quickly soluble or fast-soluble salts, such as calcium salts or magnesium salts, are defined herein as those for which an amount of the salt containing 100 mg of the elemental component thereof (Ca, Mg, etc.) fully dissolves in 100 ml of water upon gentle mixing for no more than 30 seconds at a water temperature of 90-100 degrees Celsius. Salts fitting this profile are preferred for use in the compositions of the invention.

The term “dry” as used throughout this disclosure does not mean that the referenced dry compositions are necessarily completely devoid of water; some moisture content may be present. Instead what is meant is that they are in a solid type form such as not limited to a powder, granules, a friable form or any combination thereof in the same manner, for example, as is present in a commercially available sugar packet or artificial sweetener packet that is added to a beverage (or liquid component before formation of the beverage) for dissolution/dispersion therein.

Each of the patents, patent applications and publications cited in this disclosure is incorporated by reference herein in its entirety.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A dry soluble calcium supplement composition comprising a mixture of:
one or more soluble calcium salts, collectively containing at least 50 mg of elemental calcium; and
ascorbic acid in an amount of at least 10 mg per 50 mg of elemental calcium, but no lower than 20 mg total of the ascorbic acid.

2. The composition of claim 1, further comprising one or more soluble magnesium salts.

3. The composition of claim 1, wherein
the one or more soluble calcium salts collectively contain at least 100 mg of elemental calcium.

4. The composition of claim 1, wherein the amount of ascorbic acid is at least 30 mg per 100 mg of elemental calcium.

5. The composition of claim 3, wherein the amount of ascorbic acid is at least 30 mg per 100 mg of elemental calcium.

6. The composition of claim 1, further comprising one or both of potassium phosphate and sodium bicarbonate in the mixture.

7. The composition of claim 1, further comprising vitamin D in the mixture.

8. The composition of claim 1, further comprising a sweetener in the mixture.

9. A tea bag comprising:
dry tea within the tea bag; and
a composition according to claim 1.

10. A dry instant coffee composition comprising:
instant coffee; and
a composition according to claim 1.

11. A dry soluble calcium supplement composition comprising a mixture of:
one or more soluble calcium salts;
ascorbic acid;
one or more soluble magnesium salts; and
potassium phosphate.

12. The composition of claim 11, further comprising vitamin D in the mixture.

13. The composition of claim 11, further comprising a sweetener in the mixture.

14. A tea bag comprising:
dry tea within the tea bag; and
a composition according to claim 11.

15. A dry instant coffee composition comprising:
instant coffee; and
a composition according to claim 11.

16. The composition of claim 11, wherein:
the one or more soluble calcium salts collectively contain at least 100 mg of elemental calcium: and
the amount of ascorbic acid is at least 30 mg per 100 mg of elemental calcium but not lower than 20 mg total.

17. The composition of claim 16, further comprising vitamin D in the mixture.

18. The composition of claim 16, further comprising a sweetener in the mixture.

19. A tea bag comprising:
dry tea within the tea bag; and
a composition according to claim 16.

20. A dry instant coffee composition comprising:
instant coffee; and
a composition according to claim 16.

21. A dry soluble calcium supplement composition comprising a mixture of:
one or more soluble calcium salts, collectively containing at least 50 mg of elemental calcium; and
one or more alkali salts selected from the group consisting of potassium phosphate and sodium bicarbonate.

22. A dry instant coffee composition, comprising:
the dry soluble calcium supplement composition of claim 21; and
dry instant coffee.

23. The dry instant coffee composition of claim 22, wherein,
the one or more soluble calcium salts collectively provide at least 50 mg of elemental calcium per approximately 5 ml of the dry instant coffee composition.

24. The dry instant coffee composition of claim 23, wherein,
the one or more soluble calcium salts collectively provide at least 100 mg of elemental calcium per approximately 5 ml of the dry instant coffee composition.
